(19) United States
(12) Patent Application Publication
(10) Pub. No.: US 2026/0161338 A1
(43) Pub. Date: Jun. 11, 2026

(54) ELECTRONIC APPARATUS AND METHOD FOR CONTROLLING ELECTRONIC APPARATUS

(71) Applicant: SEIKO EPSON CORPORATION, Tokyo (JP)

(72) Inventor: Tsutomu KASAI, Shimosuwa-machi (JP)

(21) Appl. No.: 19/411,433

(22) Filed: Dec. 8, 2025

(30) Foreign Application Priority Data
Dec. 9, 2024 (JP) 2024-214206

(51) Int. Cl. G06F 3/12

(52) U.S. Cl. CPC G06F 3/1287; G06F 3/1206; G06F 3/1247; G06F 3/1293

(57) ABSTRACT

An electronic apparatus is capable of relaying information between a terminal device and an image forming apparatus and includes a controller. The controller is configured to acquire specification information from the image forming apparatus by issuing a specification request command. When determining, based on the acquired specification information, that the image forming apparatus does not support a predetermined communication protocol, the controller is configured to receive, from the terminal device, image data in a predetermined format together with a print request in accordance with the predetermined communication protocol which is independent of a model of the image forming apparatus, convert the image data into the image data in accordance with a command system of the image forming apparatus, and transmit the image data to the image forming apparatus.

The present application is based on, and claims priority from JP Application Serial Number 2024-214206, filed December 9, 2024, the disclosure of which is hereby incorporated by reference herein in its entirety.

### BACKGROUND

### 1. Technical Field

The present disclosure relates to an electronic apparatus and a method for controlling an electronic apparatus.

### 2. Related Art

In general, as disclosed in JP-A-2017-34482, there is known an image forming apparatus having a communication unit for performing communication in accordance with an Internet protocol as the Internet Printing Protocol (IPP).

However, an image forming apparatus that does not support IPP may not support IPP printing or the like.

### SUMMARY

According to an aspect of the present disclosure, an electronic apparatus is capable of relaying information between a terminal device and an image forming apparatus and includes a controller. The controller is configured to acquire specification information from the image forming apparatus by issuing a specification request command. When determining, based on the acquired specification information, that the image forming apparatus does not support a predetermined communication protocol, the controller is configured to receive, from the terminal device, image data in a predetermined format together with a print request in accordance with the predetermined communication protocol which is independent of a model of the image forming apparatus, convert the image data into the image data in accordance with a command system of the image forming apparatus, and transmit the image data to the image forming apparatus.

According to an aspect of the present disclosure, an electronic apparatus is capable of relaying information between a terminal device and an image forming apparatus and includes a controller. The controller is configured to acquire specification information from the image forming apparatus by issuing a specification request command. When determining, based on the acquired specification information, that the image forming apparatus does not support a predetermined communication protocol, the controller is configured to receive, from the terminal device, an image acquisition request in accordance with the predetermined communication protocol which is independent of a model of the image forming apparatus, convert the image acquisition request into an image acquisition command based on a command system of the image forming apparatus, and transmit the image acquisition command to the image forming apparatus.

According to an aspect of the present disclosure, a method for controlling an electronic apparatus capable of relaying information between a terminal device and an image forming apparatus includes acquiring specification information from the image forming apparatus by issuing a specification request command, when determining, based on the acquired specification information, that the image forming apparatus does not support a predetermined communication protocol, receiving, from the terminal device, image data in a predetermined format together with a print request according to the predetermined communication protocol independent of a model of the image forming apparatus, converting the image data into the image data conforming to a command system of the image forming apparatus, and transmitting the image data to the image forming apparatus.

### BRIEF DESCRIPTION OF THE DRAWINGS

FIG. 1 is a diagram schematically illustrating a configuration of an image forming system including an electronic apparatus.

FIG. 2 is a flowchart illustrating processing of the electronic apparatus.

### DESCRIPTION OF EMBODIMENTS

### 1. Configuration of Image Forming System

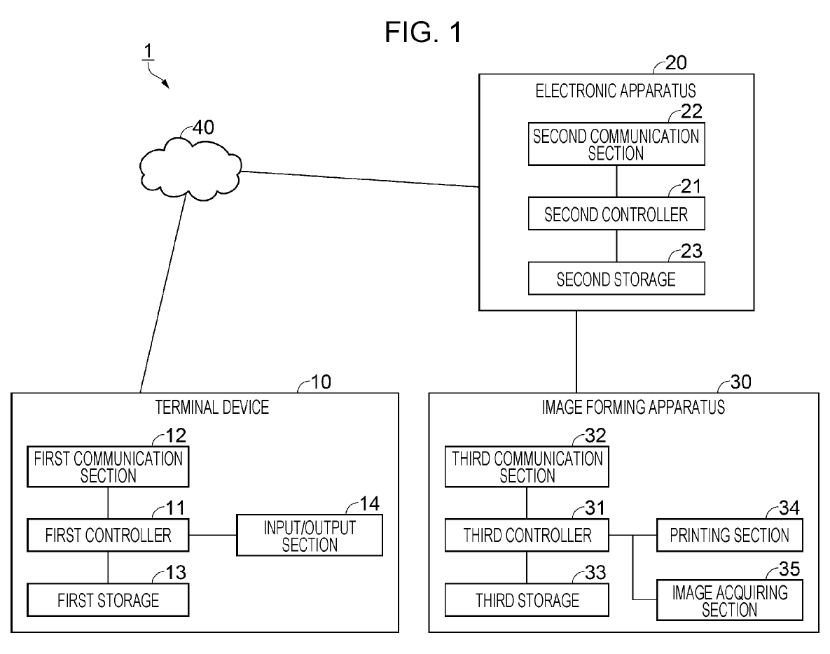

As illustrated in FIG. 1, an image forming system 1 includes a terminal device 10, an electronic apparatus 20, and an image forming apparatus 30.

The terminal device 10 and the electronic apparatus 20 can communicate with each other via, for example, a wide area network (WAN) 40 which is the Internet. Note that the WAN 40 may be a network, such as a local area network (LAN).

For example, unique Internet protocol addresses (IP addresses) are individually assigned to the terminal device 10 and the electronic apparatus 20. The terminal device 10 and the electronic apparatus 20 can specify an IP address assigned to a communication destination to communicate with the communication destination.

The electronic apparatus 20 and the image forming apparatus 30 may communicate with each other via, for example, a universal serial bus (USB).

The electronic apparatus 20 may be, for example, a concentrator having a function of communicating with a plurality of devices. The concentrator may be simply referred to as a hub. Alternatively, the electronic apparatus 20 may be an apparatus having a communication function, such as a smartphone, a tablet terminal, or a personal computer (PC), or may be another electronic apparatus. Note that the electronic apparatus 20 is not limited to a portable apparatus and may be a stationary apparatus. The electronic apparatus 20 includes a second controller 21, a second communication section 22, and a second storage 23.

The second controller 21 integrally controls the individual sections of the electronic apparatus 20. The second controller 21 includes a central processing unit (CPU), a universal asynchronous receiver transmitter (UART) that manages input and output, a field programmable gate array (FPGA) or a programmable logic device (PLD) that is a logic circuit, and the like. The second controller 21 is also referred to as a processor. Note that the CPU of the second controller 21 may be particularly referred to as a processor. Hereinafter, the second controller 21 is also simply referred to as a controller.

The second storage 23 includes a memory, such as a flash read only memory (ROM) or a hard disk drive (HDD) that is a rewritable nonvolatile memory, and a random access memory (RAM) that is a volatile memory. Note that the nonvolatile memory of the second storage 23 may include a solid state drive (SSD).

The CPU of the second controller 21 reads a program stored in the nonvolatile memory of the second storage 23 and executes the program by using the RAM of the second storage 23 as a work area.

The second communication section 22 includes a circuit capable of performing wireless or wired communication. Note that the second communication section 22 includes an antenna for wireless communication or a connector for wired communication.

The second communication section 22 may communicate with the terminal device 10 via the Internet, which is a first communication method. The second communication section 22 may also communicate with a plurality of image forming apparatuses 30 by USB which is a second communication method.

Note that the electronic apparatus 20 transmits and receives data to and from a communication destination via the second communication section 22, but in the following description, the transmission and reception via the second communication section 22 will be omitted for the sake of simplicity. The same applies to a first communication section 12 of the terminal device 10 and a third communication section 32 of the image forming apparatus 30 to be described later.

The image forming apparatus 30 includes a third controller 31, the third communication section 32, and a third storage 33. These components of the image forming apparatus 30 are substantially the same as those of the electronic apparatus 20 described above, and thus the description thereof will be omitted.

Note that the third communication section 32 can communicate with the electronic apparatus 20 via a USB. In the image forming system 1, a plurality of image forming apparatuses 30 may be connected to the electronic apparatus 20.

The image forming apparatus 30 includes a printing section 34. The printing section 34 is configured to include a printing mechanism, such as a head and a transport roller (both not illustrated). A medium printed by the printing section 34 is, for example, plain paper, synthetic paper, photographic paper, film, or the like.

The head is, for example, of an ink jet type, and performs printing by ejecting inks of a plurality of colors, such as CMYK (Cyan, Magenta, Yellow, and Black). The head may be a thermal head, an electrophotographic head, or the like.

The image forming apparatus 30 further includes an image acquiring section 35. The image acquiring section 35 includes a scanner (not illustrated), and can acquire an image of a document as a medium.

The image forming apparatus 30 can perform media processing, such as printing, scanning, copying, and FAX using the printing section 34, the image acquiring section 35, and the like. Such image forming apparatus 30 is also referred to as a multifunction peripheral.

The terminal device 10 is, for example, a smartphone, a tablet terminal, a computer, or the like. The terminal device 10 includes a first controller 11, the first communication section 12, and a first storage 13. Since these components of the terminal device 10 are substantially the same as the components of the electronic apparatus 20 described above, the description thereof will be omitted.

Note that the first communication section 12 can communicate with the electronic apparatus 20 via the WAN 40.

The terminal device 10 further includes an input/output section 14. The input/output section 14 is a user interface for a user.

The input/output section 14 is, for example, a touch panel display. The input/output section 14 includes a display panel serving as an output section for displaying various types of information and a detection panel serving as an input section.

The detection panel is superposed on the display panel. The detection panel can detect an operation with a user's finger or the like by using a method, such as a capacitive method, a resistive film method, or an optical method.

In the input/output section 14, the input section may be a keyboard, a mouse, a button, or the like, and the output section may be a stand-type liquid crystal display or the like.

### 2. IPP

Here, for convenience of description, it is assumed that the terminal device 10 and the image forming apparatus 30 communicate with each other in accordance with Internet Printing Protocol (IPP), which is a predetermined communication protocol, without involving the electronic apparatus 20, which is different from FIG. 1. As an example, processing performed when the both sides transmit and receive image data will be described. It is assumed that an image data is formed in a predetermined format, such as PWG-Raster, JPEG, or PDF.

Note that, in the following description, the first controller 11 of the terminal device 10 and the third controller 31 of the image forming apparatus 30 actually execute respective processes. In order to simplify the description, the following description will be made by omitting execution of the processes by the individual controllers.

Before IPP is described, a so-called vendor driver will be described. Hereinafter, the vendor driver is simply referred to as a driver.

A manufacturer or a distributor of the image forming apparatus 30 prepares a driver for each model of the image forming apparatus 30 and provides the driver to a user of the image forming apparatus 30. The user may install the driver in the first storage 13 of the terminal device 10 and issue a print instruction or the like from the terminal device 10 to the image forming apparatus 30.

The image forming apparatus 30 has a unique command system in the third storage 33. Various commands included in the command system are optimized for each model in accordance with the specifications of the printing section 34, the image acquiring section 35, and the like included in the image forming apparatus 30. Therefore, the driver is also different for each model. Note that the driver includes functions of image processing, such as color conversion and halftone processing, for image data acquired using an application.

The driver of the terminal device 10 generates and transmits a command conforming to the command system of the image forming apparatus 30 based on an instruction issued by the application or an input to the input/output section 14 by the user.

The image forming apparatus 30 reads firmware stored in the third storage 33, controls the printing section 34, the image acquiring section 35, and the like in response to the received command, and executes printing, image acquisition, and the like.

On the other hand, an operating system (OS) provider may provide an OS with functions capable of printing, image acquisition, and the like. These functions included in the OS are not dependent on a model of the image forming apparatus 30 and are realized using IPP as a standard common to various types of image forming apparatus 30. The OS is installed in the terminal device 10. The OS of the terminal device 10 can transmit and receive information using IPP in common to models of the image forming apparatuses 30.

IPP is a communication protocol that enables the terminal device 10 to, for example, control the image forming apparatus 30 via the Internet. IPP is an extended standard of Hyper Text Transfer Protocol (HTTP), and supports access control, authentication, encryption, and the like.

The terminal device 10 and the image forming apparatus 30 may be connected to each other via a USB and may be compliant with the "IPP over USB" standard for IPP, as will be described later.

The terminal device 10 operates as a web client that makes an HTTP request, and the image forming apparatus 30 operates as a web server that makes an HTTP response. The terminal device 10 and the image forming apparatus 30 can transmit and receive web data.

In particular, in a case where both are compliant with IPP, the terminal device 10 is also referred to as an IPP client that makes an IPP request, and the image forming apparatus 30 is also referred to as an IPP server that makes an IPP response to the IPP request. The IPP request is based on IPP which is a predetermined communication protocol independent of a model of the image forming apparatus 30, and the IPP response is based on IPP which is a predetermined communication protocol independent of the model of the image forming apparatus 30.

When the image forming apparatus 30 supports IPP, a program referred to as an IPP object, which is an object, is stored in the third storage 33. The image forming apparatus 30 reads the IPP object from the third storage 33 and executes the IPP object. Note that the IPP object also includes functions of image processing, such as color conversion and halftone processing, for image data.

The image forming apparatus 30 can receive the IPP request from the terminal device 10, execute the IPP object, and transmit a result to the terminal device 10 as an IPP response.

In this case, the terminal device 10 may not use various commands included in the unique command system of the image forming apparatus 30. That is, the terminal device 10 may not use different commands for individual models of the image forming apparatus 30, and only needs to transmit an IPP request according to the IPP standard. Therefore, the terminal device 10 may not use a driver.

In some cases, the image forming apparatus 30 does not store the IPP object and does not support IPP. In this case, even if an IPP request is made from the terminal device 10, the image forming apparatus 30 may not perform printing or the like in response. Furthermore, in some cases, the terminal device 10 attempts to use both the IPP-compatible image forming apparatus 30 and the IPP-incompatible image forming apparatus 30. Therefore, the electronic apparatus 20 plays a role of relaying while supporting both of them as follows.

### 3. Relaying by Electronic Apparatus

As illustrated in FIG. 1, the electronic apparatus 20 is also a relay apparatus that is interposed between the terminal device 10 and the image forming apparatus 30 and can relay information to be transmitted and received. That is, the electronic apparatus 20 transmits the information received from the terminal device 10 to the image forming apparatus 30. Furthermore, the electronic apparatus 20 transmits information received from the image forming apparatus 30 to the terminal device 10. The electronic apparatus 20 supports both the IPP-compatible image forming apparatus 30 and the IPP-incompatible image forming apparatus 30.

In the following description, the second controller 21 of the electronic apparatus 20 actually executes individual processes. In order to simplify the description, the second controller 21 executing the processes will be omitted in the following description. The same applies to the controllers of the other devices.

### 3-1. IPP-Compatible Image Forming Apparatus 30

First, a case where the image forming apparatus 30 supports IPP as described above will be described. In this case, the electronic apparatus 20 relays information transmitted and received between the terminal device 10 and the IPP-compatible image forming apparatus 30 without conversion or the like. Hereinafter, "relay without conversion or the like" and "relay without conversion" are also referred to as "pass through".

That is, the electronic apparatus 20 transmits information received from the terminal device 10 to the image forming apparatus 30 without conversion or the like.

Note that, in this case, the electronic apparatus 20 and the image forming apparatus 30 are connected to each other by USB, and conform to a standard referred to as "IPP over USB". "IPP over USB" is a standard capable of performing communication in accordance with IPP via USB. The electronic apparatus 20 and the image forming apparatus 30 can communicate with each other by IPP via USB. Note that the electronic apparatus 20, for example, changes a format of communication to USB for the image forming apparatus 30.

As an example, a process of transmitting and receiving image data in a predetermined format as described above via the electronic apparatus 20 will be described below.

In the terminal device 10, the OS acquires image data in a predetermined format as described above from an application. The OS transmits image data in the predetermined format to the image forming apparatus 30 via the electronic apparatus 20 together with an IPP request for printing. The electronic apparatus 20 passes through the IPP request, the image data in the predetermined format, and the like, that is, relays the IPP request, the image data, and the like without conversion.

In this case, the image forming apparatus 30 directly receives the image data in the predetermined format together with the IPP request, instead of a command including image data generated by the driver.

The IPP object has a function of interpreting the received IPP request and converting the IPP request into a command of the command system of the image forming apparatus 30. This function is stored in the third storage 33 as a portion of a program constituting the IPP object, and can be read and executed by the image forming apparatus 30.

Since the image forming apparatus 30 has the conversion function included in the IPP object, the image forming apparatus 30 is compatible with IPP and can internally convert information. The IPP object also includes the above-described image processing function.

The image forming apparatus 30 executes the IPP object, and temporarily converts the received IPP request and the image data in the predetermined format into a print command which is related to printing and includes image data conforming to its own command system. Next, the image forming apparatus 30 can execute the above-described firmware, control the printing section 34 in accordance with the converted print command, and print the image data included in the print command.

The image forming apparatus 30 transmits a print result, which is a processing result, as an IPP response to the terminal device 10 via the electronic apparatus 20. The electronic apparatus 20 passes through the print result, that is, relays the print result without conversion. The terminal device 10 can receive the print result as an IPP response. The print result is, for example, information indicating that the printing has been successfully performed or failed.

Furthermore, as another example, in the terminal device 10, the OS can transmit an IPP request for requesting image acquisition to the image forming apparatus 30 via the electronic apparatus 20 based on a scan instruction or the like issued to the input/output section 14 by the user. This IPP request can also specify a format of the image data to be acquired. The electronic apparatus 20 passes through the IPP request, that is, relays the IPP request without conversion.

The image forming apparatus 30 executes the IPP object in response to the received IPP request. Specifically, the image forming apparatus 30 interprets the received IPP request by the IPP object, and internally converts the IPP request into an image acquisition command related to image acquisition according to its own command system. The image forming apparatus 30 can control the image acquiring section 35 in response to the converted image acquisition command by the above-described firmware and execute acquisition of image data.

Next, the image forming apparatus 30 generates the acquired image data as image data in a format corresponding to its own command system by the firmware. The image forming apparatus 30 executes the IPP object, converts the image data generated by the firmware into a format designated by the IPP request, and sets the converted image data as an IPP response. The image forming apparatus 30 transmits the IPP response to the terminal device 10 via the electronic apparatus 20. The electronic apparatus 20 passes through the IPP response, that is, relays the IPP response without conversion. That is, the electronic apparatus 20 transmits the information received from the image forming apparatus 30 to the terminal device 10 without conversion or the like. The terminal device 10 can receive the image data in the designated format as the IPP response.

The image forming apparatus 30 can support IPP for the terminal device 10 via the electronic apparatus 20 by using the IPP object as described above. Specifically, since the image forming apparatus 30 has the conversion function included in the IPP object, the image forming apparatus 30 can support IPP related to printing, image acquisition, and the like for the terminal device 10 via the electronic apparatus 20.

### 3-2. IPP-Incompatible Image Forming Apparatus 30

Next, a case where the image forming apparatus 30 does not support IPP will be described. In this case, the image forming apparatus 30 does not support IPP, but supports its own command system by the firmware.

The electronic apparatus 20 supports IPP, and executes conversion of information to be transmitted and received between the terminal device 10 and the IPP-incompatible image forming apparatus 30, similarly to the above-described IPP-compatible image forming apparatus 30.

As in the case of the IPP-compatible image forming apparatus 30 described above, the electronic apparatus 20 stores an IPP object in the second storage 23, and reads and executes the IPP object. In this case, the electronic apparatus 20 operates as the above-described IPP server.

Hereinafter, the electronic apparatus 20 will be described focusing on differences from the case of the above-described IPP-compatible image forming apparatus 30, and a portion of the same contents will be omitted.

In the terminal device 10, the OS transmits image data in a predetermined format to the electronic apparatus 20 together with an IPP request for printing.

The electronic apparatus 20 executes the IPP object for the received IPP request and the image data in the predetermined format. Specifically, the electronic apparatus 20 interprets the received IPP request by the IPP object, and converts the image data in the predetermined format into a print command including image data according to the command system of the image forming apparatus 30, which is a command related to printing.

The electronic apparatus 20 transmits the converted print command, and the image forming apparatus 30 receives the print command. The image forming apparatus 30 can execute printing of the image data by controlling the printing section 34 in response to the print command by the above-described firmware.

The electronic apparatus 20 receives a print result as a processing result from the image forming apparatus 30 by issuing a processing result request command which is a command conforming to the command system of the image forming apparatus 30 and which requests a processing result, converts the print result into an IPP response, and transmits the IPP response to the terminal device 10.

Furthermore, as another example, in the terminal device 10, the OS transmits, to the electronic apparatus 20, an IPP request for requesting image acquisition. The IPP request may also specify a format of the requested image data.

The electronic apparatus 20 executes the IPP object in response to the received IPP request. Specifically, the electronic apparatus 20 interprets the received IPP request by the IPP object, and converts the IPP request into an image acquisition command related to image acquisition.

The electronic apparatus 20 transmits the converted image acquisition command, and the image forming apparatus 30 receives the converted image acquisition command. The image forming apparatus 30 executes the firmware, controls the image acquiring section 35 in response to the image acquisition command, and acquires image data. Then, the image forming apparatus 30 generates image data in a format conforming to its own command system and transmits the image data to the electronic apparatus 20.

The electronic apparatus 20 receives the image data generated by the image forming apparatus 30, converts the image data into a format designated by the IPP request using the IPP object, and transmits the converted image data to the terminal device 10 as an IPP response. The terminal device 10 can receive the image data in the designated format.

The electronic apparatus 20 can support IPP for the terminal device 10 by the IPP object as described above. Specifically, since the electronic apparatus 20 has the conversion function included in the IPP object, the electronic apparatus 20 can support IPP related to printing, image acquisition, and the like for the terminal device 10. Furthermore, the electronic apparatus 20 can convert the IPP request from the terminal device 10 into a command conforming to the command system of the IPP-incompatible image forming apparatus 30, and cause the image forming apparatus 30 to perform printing, image acquisition, and the like.

### 4. Method for Controlling Electronic Apparatus

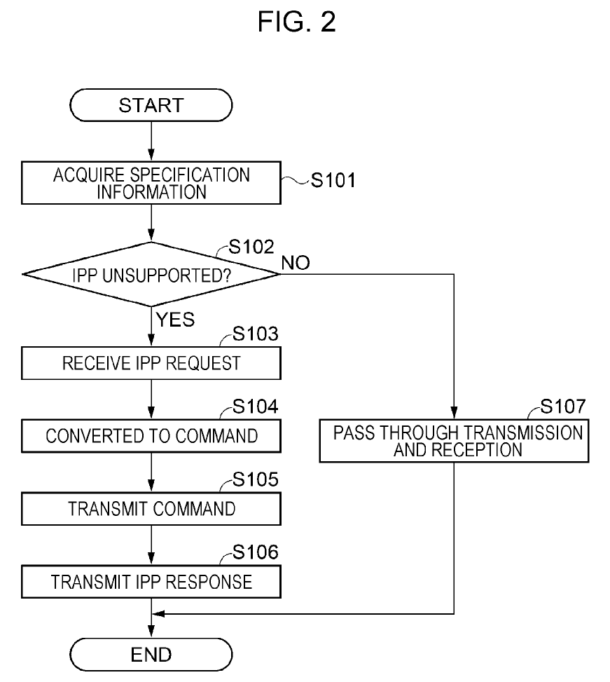

A method of controlling the electronic apparatus 20 will be described with reference to FIG. 2. The electronic apparatus 20 and the terminal device 10 communicate with each other by IPP. In addition, the electronic apparatus 20 transmits and receives information after passing through the information or after converting the information in accordance with the IPP-compatible image forming apparatus 30 or the IPP-incompatible image forming apparatus 30. Hereinafter, the same contents as those of the above-described "Relaying by Electronic Apparatus" will be omitted.

The electronic apparatus 20 starts a process and acquires specification information from the image forming apparatus 30 (S101).

The image forming apparatus 30 stores the specification information, which is information on specifications related to the image forming apparatus 30, in the third storage 33. The specification information includes, for example, information on the specifications of the printing section 34 and the image acquiring section 35, information on a provided command system, and information on whether IPP is supported or not.

The electronic apparatus 20 transmits a specification request command, which is a command for requesting the specification information, to the image forming apparatus 30. In response to the specification request command, the image forming apparatus 30 reads the specification information from the third storage 33 and transmits the specification information to the electronic apparatus 20. Note that it is assumed that the specification request command is common to the models of the image forming apparatus 30, and does not depend on the command systems of the models.

Note that the electronic apparatus 20 may transmit the acquired specification information of the image forming apparatus 30 as an IPP response to the IPP request from the terminal device 10.

The electronic apparatus 20 determines, based on the specification information acquired from the image forming apparatus 30, whether IPP is unsupported (S102).

When the acquired specification information indicates that IPP is unsupported, the electronic apparatus 20 determines that IPP is unsupported by the image forming apparatus 30 (S102: YES). Thereafter, the electronic apparatus 20 executes the IPP object and performs processing corresponding to IPP related to printing, image acquisition, and the like in place of the image forming apparatus 30.

For example, it is assumed that the electronic apparatus 20 receives an IPP request for requesting printing and image data in a predetermined format from the terminal device 10 (S103). The IPP request for requesting printing is a print request by IPP which is a predetermined communication protocol independent of the model of the image forming apparatus 30.

The electronic apparatus 20 executes the IPP object for the received IPP request and the image data in the predetermined format, and converts the IPP request and the image data in the predetermined format into a print command which is a command relating to printing and includes image data according to the command system of the image forming apparatus 30 (S104).

The electronic apparatus 20 transmits the converted print command to the image forming apparatus 30 (S105). The image forming apparatus 30 can control the printing section 34 in accordance with the converted print command by the firmware and execute printing of the image data included in the print command.

The electronic apparatus 20 can transmit, to the image forming apparatus 30, a processing result request command that is conforming to the command system of the image forming apparatus 30 and that is for requesting a print result as a processing result, receive the print result from the image forming apparatus 30, and transmit, to the terminal device 10, the print result as an IPP response (S106). The electronic apparatus 20 ends the process.

As described above, even when the image forming apparatus 30 does not support IPP, the electronic apparatus 20 can support IPP related to printing or the like for the terminal device 10 by executing the IPP object, and can support the image forming apparatus 30 that does not support IPP using the command according to the command system.

Note that, when the electronic apparatus 20 acquires the specification information from the image forming apparatus 30, the electronic apparatus 20 can also acquire detailed information related to the printing section 34 and the image acquiring section 35, such as sheet information including a width, a margin, and a length of a sheet, resolution of the head, and resolution of the scanner.

The electronic apparatus 20 can more appropriately perform conversion into a command conforming to the command system of the image forming apparatus 30 based on the detailed information included in the acquired specification information. For example, the electronic apparatus 20 can convert the image data into a print command for enlargement, size-reduction, layout, or the like.

In addition, the electronic apparatus 20 can transmit, based on the IPP request related to the specification information from the terminal device 10, the detailed information included in the acquired specification information as an IPP response. The terminal device 10 can make, based on the detailed information included in the received specification information, a detailed IPP request related to printing or image acquisition.

On the other hand, when it is determined that IPP is supported by the image forming apparatus 30 (S102: NO), the electronic apparatus 20 passes through the information to be transmitted and received (S107). That is, when it is determined that the image forming apparatus 30 is IPP compatible, the electronic apparatus 20 passes through the IPP request or the like, that is, relays the IPP request without conversion. The electronic apparatus 20 does not convert the image data in the predetermined format together with the IPP request for printing.

In this case, the image forming apparatus 30 can execute the IPP object and can respond to the IPP request related to printing or image acquisition received from the terminal device 10 via the electronic apparatus 20.

Separately, an example of the image acquisition will be described. As described above, it is assumed that the electronic apparatus 20 acquires the specification information from the image forming apparatus 30 (S101), and determines that IPP is unsupported (S102: YES).

The electronic apparatus 20 receives, from the terminal device 10, an IPP request for requesting image acquisition (S103). The IPP request for requesting image acquisition is an image acquisition request by IPP which is a predetermined communication protocol independent of the model of the image forming apparatus 30.

The electronic apparatus 20 executes an IPP object in response to the received IPP request, and converts the IPP request into an image acquisition command which is a command related to image acquisition in accordance with the command system of the image forming apparatus 30 (S104). The IPP request may also specify a format of the image data.

The electronic apparatus 20 transmits the converted image acquisition command to the image forming apparatus 30 (S105). The image forming apparatus 30 can control the image acquiring section 35 in response to the image acquisition command by the firmware and execute the acquisition of the image data.

The image forming apparatus 30 generates image data in a format corresponding to its own command system using the acquired image data and transmits the image data to the electronic apparatus 20.

The electronic apparatus 20 executes the IPP object, converts the format of the image data received from the image forming apparatus 30 into the format specified by the IPP request, and transmits, to the terminal device 10, the converted image data as an IPP response (S106). The terminal device 10 can receive the image data in the designated format. The electronic apparatus 20 ends the process.

As described above, even when the image forming apparatus 30 does not support IPP, the electronic apparatus 20 can support IPP related to image acquisition or the like for the terminal device 10 by executing the IPP object, and can support the image forming apparatus 30 that does not support IPP by the image acquisition command according to the command system.

Note that the electronic apparatus 20 can be connected to a plurality of image forming apparatuses 30. The electronic apparatus 20 can acquire the specification information of the individual image forming apparatuses 30 and determine whether each of the image forming apparatuses 30 supports IPP or does not support IPP. The electronic apparatus 20 can relay the information to each of the image forming apparatuses 30 by converting the information or passing through the information to each of the image forming apparatuses 30 without converting the information as described above in accordance with a determination result while supporting IPP for the terminal device 10.

In addition, the electronic apparatus 20 acquires state information from the image forming apparatus 30 by using a state request command that conforms to the command system and that is for requesting the state information that is information related to a state of the image forming apparatus 30. The electronic apparatus 20 can transmit the acquired state information to the terminal device 10 by the IPP object.

The state information of the image forming apparatus 30 includes, for example, a state of the printing section 34 such as printing, an idle state, or printing completion, and a state of the image acquiring section 35, such as image acquisition, an idle state, or image acquisition completion. In addition, the state information includes information indicating an amount of remaining consumables, such as ink and a medium. In addition, the state information includes information related to warnings, such as an error that has occurred in the printing section 34 and the image acquiring section 35, the absence of consumables, and the opening of a cover.

The terminal device 10 can acquire, using IPP, the state information of the image forming apparatus 30 from the electronic apparatus 20, display the state information on the input/output section 14, and make an IPP request based on the state information.

As described above, the electronic apparatus 20 is capable of relaying information between the terminal device 10 and the image forming apparatus 30, and includes the second controller 21 as a controller.

When the second controller 21 determines, based on the specification information acquired from the image forming apparatus 30 by issuing the specification command, that the image forming apparatus 30 does not support IPP as the predetermined communication protocol, the second controller 21 receives image data in a predetermined format from the terminal device 10 together with a print request by IPP independent of the model of the image forming apparatus 30, converts the image data into image data conforming to the command system of the image forming apparatus 30, and transmits the image data to the image forming apparatus 30.

As a result, even in the case of the image forming apparatus 30 that does not support IPP, the electronic apparatus 20 can relay information between the terminal device 10 and the image forming apparatus 30, convert the information, and support printing or the like by IPP.

Although embodiments have been described in detail with reference to the drawings, specific configurations are not limited to these embodiments, and modifications, substitutions, eliminations, and the like may be made without departing from the gist of the present disclosure.

What is claimed is:

1. An electronic apparatus capable of relaying information between a terminal device and an image forming apparatus, the electronic apparatus comprising a controller, wherein
the controller is configured to
acquire specification information from the image forming apparatus by issuing a specification request command,
when determining, based on the acquired specification information, that the image forming apparatus does not support a predetermined communication protocol,
receive, from the terminal device, image data in a predetermined format together with a print request in accordance with the predetermined communication protocol which is independent of a model of the image forming apparatus,
convert the image data into the image data in accordance with a command system of the image forming apparatus, and
transmit the image data to the image forming apparatus.

2. The electronic apparatus according to claim 1, wherein the controller is configured to
when determining, based on the acquired specification information, that the image forming apparatus supports the predetermined communication protocol,
receive the image data in the predetermined format together with the print request from the terminal device, and
transmit the image data without conversion to the image forming apparatus.

3. The electronic apparatus according to claim 2, wherein
the electronic apparatus is connectable to a plurality of image forming apparatuses, and
the controller is configured to
determine, based on the acquired specification information, whether each of the image forming apparatuses supports or does not support the predetermined communication protocol,
receive the image data in the predetermined format together with the print request from the terminal device, and
transmit the image data to the image forming apparatus after conversion or without conversion in accordance with a result of the determining.

4. The electronic apparatus according to claim 1, wherein
the controller is configured to acquire state information from the image forming apparatus by sending a state request command, and transmit the state information to the terminal device in accordance with the predetermined communication protocol.

5. The electronic apparatus according to claim 1, wherein
the controller is configured to transmit the acquired specification information to the terminal device in accordance with the predetermined communication protocol.

6. An electronic apparatus capable of relaying information between a terminal device and an image forming apparatus, the electronic apparatus comprising a controller, wherein
the controller is configured to
acquire specification information from the image forming apparatus by issuing a specification request command,
when determining, based on the acquired specification information, that the image forming apparatus does not support a predetermined communication protocol,
receive, from the terminal device, an image acquisition request in accordance with the predetermined communication protocol which is independent of a model of the image forming apparatus,
convert the image acquisition request into an image acquisition command based on a command system of the image forming apparatus, and
transmit the image acquisition command to the image forming apparatus.

7. A method for controlling an electronic apparatus capable of relaying information between a terminal device and an image forming apparatus, the method comprising:
acquiring specification information from the image forming apparatus by issuing a specification request command,
when determining, based on the acquired specification information, that the image forming apparatus does not support a predetermined communication protocol,
receiving, from the terminal device, image data in a predetermined format together with a print request according to the predetermined communication protocol independent of a model of the image forming apparatus,
converting the image data into the image data conforming to a command system of the image forming apparatus, and
transmitting the image data to the image forming apparatus.
